(19) United States
(12) Patent Application Publication
(10) Pub. No.: US 2022/0175618 A1
(43) Pub. Date: Jun. 9, 2022

(54) PILL ORGANIZER

(71) Applicant: Hong Kong Abby Technology Co., Ltd, Kowloon (HK)

(72) Inventor: Yanfei WANG, Guangdong (CN)

(73) Assignee: Hong Kong Abby Technology Co., Ltd, KOWLOON (HK)

(21) Appl. No.: 17/114,871

(22) Filed: Dec. 8, 2020

(51) Int. Cl. A61J 7/00; A61J 1/03

(52) U.S. Cl. CPC A61J 7/0084; A61J 1/03

(57) ABSTRACT

A pill organizer has a sorting box slidably mounted in an outer housing. The sorting box has multiple pill compartments and two box-positioning portions. The outer housing has an outer tube, an upper half tube, and a lower half tube. The upper half tube and the lower half tube are mounted in the outer tube from opposite directions and interlocks with each other. The sorting box is slidably mounted between the upper half tube and the lower half tube. The lower half tube has multiple housing-positioning portions disposed apart from each other along a lengthwise direction of the sorting box. The two box-positioning portions of the sorting box selectively engage with the housing-positioning portions to keep the pill compartments protruded from the outer housing or to keep all the pill compartments retracted for ease of use.

### BACKGROUND OF THE INVENTION

### 1. Field of the Invention

The present invention relates to a matchbox pill organizer.

### 2. Description of the Prior Arts

A pill organizer is a multi-compartment container for storing scheduled pills. The pill organizer usually has at least seven pill compartments for storing medications for each day of a week. Each pill compartment has an independent lid to open and close the pill compartment.

However, due to the amount of lids, the conventional pill organizer has a lot of parts to be assembled during manufacturing and is complex in structure, which increases cost. Moreover, the lids may accidentally pop open when the pill organizer is dropped or placed in a packed bag during travelling.

To overcome the shortcomings, the present invention provides a pill organizer to mitigate or obviate the aforementioned problems.

### SUMMARY OF THE INVENTION

The main objective of the present invention is to provide a matchbox pill organizer that has few parts to be assembled and will not be opened accidentally.

The pill organizer has a sorting box and an outer housing. The sorting box has a main body, multiple partitions, and at least one box-positioning portion. The main body extends along a lengthwise direction and forms an inner space and a top opening. The partitions are located in the main body and disposed apart from each other along the lengthwise direction to divide the inner space of the main body into multiple pill compartments. The at least one box-positioning portion is formed on an external surface of the sorting box. The outer housing is slidably located around the sorting box and has an outer tube, an upper half tube, and a lower half tube. The outer tube has two end openings located on two opposite ends of the outer tube, and the two end openings being respectively a first opening and a second opening. The upper half tube is mounted in the outer tube from the first opening and covers at least part of the top opening. The upper half tube has an upper abutting surface and multiple upper locking portions. The upper abutting surface is directed toward the second opening and adapted to abut against the outer tube to stop the upper half tube from moving toward the second opening. The upper locking portions are formed on a bottom of the upper half tube. The lower half tube is mounted in the outer tube from the second opening. A sliding channel is formed between the upper half tube and the lower half tube. The sorting box is slidably mounted in the sliding channel. The lower half tube has a lower abutting surface, multiple lower locking portions, and multiple housing-positioning portions. The lower abutting surface is directed toward the first opening and adapted to abut against the outer tube to stop the lower half tube from moving toward the first opening. The lower locking portions are formed on a top of the lower half tube and engage with the upper locking portions to keep the upper half tube and the lower half tube connected to each other in the outer tube. The housing-positioning portions are disposed apart from each other along the lengthwise direction. The at least one box-positioning portion of the sorting box selectively engages with one of the housing-positioning portions to keep at least one of the pill compartments protruded from the sliding channel or to keep all the pill compartments retracted in the sliding channel.

To use the pill organizer, put pills in the pill compartments according to prescription. Push an end of the sorting box along the lengthwise direction to force the sorting box to protrude from the outer housing until the desired pill compartment is protruded from the outer housing.

The advantages of the invention are:

First, because all pill compartments of the sorting box are mounted in one single outer housing, the pill organizer has few parts to be assembled during manufacturing, and all parts are simple in structure, thereby saving cost.

Second, the sorting box is commonly retracted inside the outer housing, and relative movement between the sorting box and the outer housing is restricted by the positioning portions. Therefore, the sorting box protrudes from the outer housing only when pushed intentionally by finger of a user, thereby preventing accidentally opening the outer housing.

Third, when the sorting box is protruded from the outer housing, relative movement between the sorting box and the outer housing is restricted by the positioning portions for ease of use.

Fourth, it is difficult to manufacture if the housing-positioning portions were directly formed in the outer tube. By forming the housing-positioning portions in the upper half tube, the upper half tube and the lower half tube are mounted from opposite directions into the outer tube, and finally the upper half tube and the lower half tube are fixed together using the locking portions, so the present invention can be manufactured and assembled with ease.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pill organizer in accordance with the present invention;

FIG. 2 is an exploded view of the pill organizer in FIG. 1;

FIG. 3 is an exploded view of an outer housing of the pill organizer;

FIG. 4 is a cross-sectional view of the pill organizer in FIG. 1;

FIGS. 5 and 6 are cross-sectional views of the pill organizer, showing different operating statuses of the pill organizer;

FIG. 7 is a schematic perspective view of the pill organizer, showing one pill compartment protruded from the outer housing; and

FIG. 8 is another sectional view of the pill organizer in FIG. 1.

### DETAILED DESCRIPTION OF THE PREFERRED EMBODIMENTS

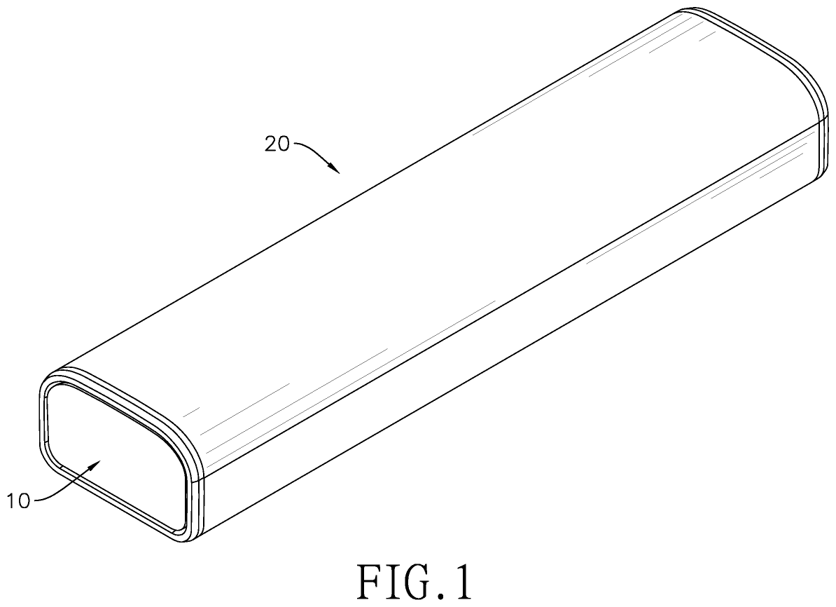

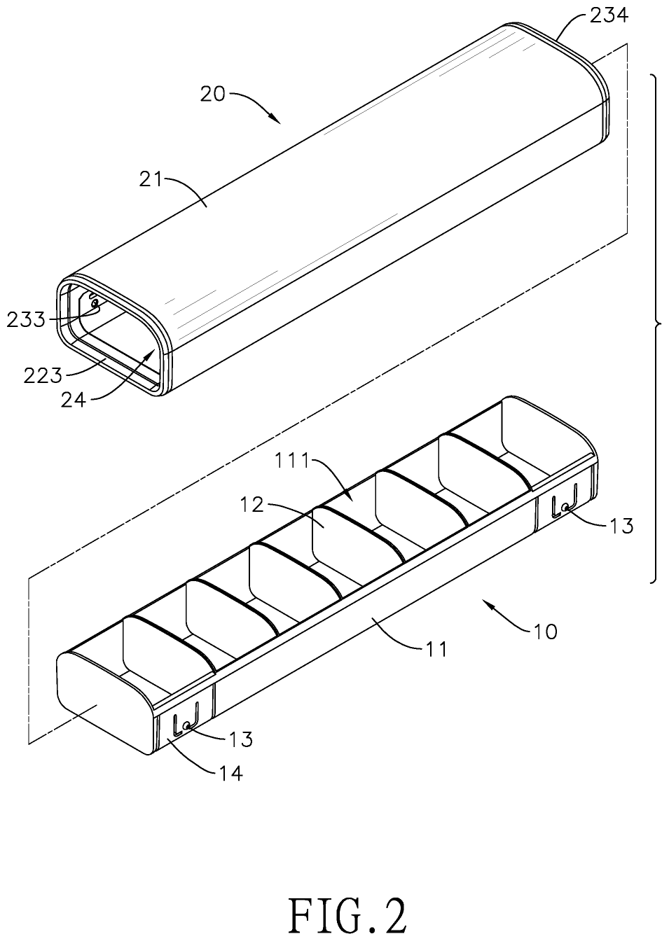

With reference to FIGS. 1 to 3, a pill organizer in accordance with the present invention comprises a sorting box 10 and an outer housing 20.

The sorting box 10 has a main body 11, multiple partitions 12, and two box-positioning portions 13. The main body 11 extends along a lengthwise direction L and forms an inner space and a top opening. The partitions 12 are located in the main body 11 and disposed apart from each other along the lengthwise direction L to divide the inner space of the main body 11 into multiple pill compartments 111 for organizing pills. The two box-positioning portions 13 are formed on an external surface of the sorting box 10, and each one of the box-positioning portions 13 is preferably a round bump. Each one of the two box-positioning portions 13 is preferably located on a side of the sorting box 10.

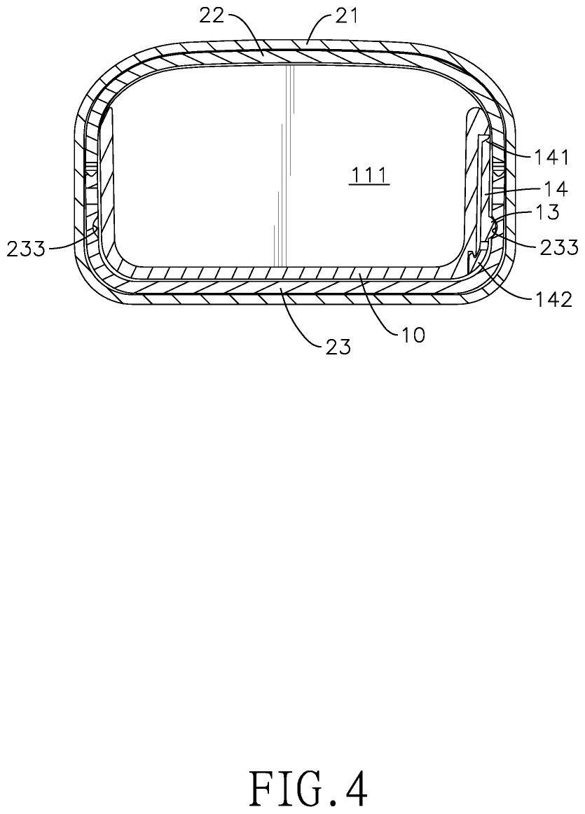

With reference to FIGS. 4, 5, and 7, in the preferred embodiment, the sorting box 10 has two positioning panels 14 disposed apart from an external surface of the main body 11, and the two box-positioning portions 13 are formed on the two positioning panels 14 respectively such that when the box-positioning portions 13 engage with or disengage from housing-positioning portions 233 mentioned afterwards, the positioning panels 14 deform elastically to reduce force exerted on the box-positioning portions 13, thereby improving durability of the box-positioning portions 13. Each one of the positioning panels 14 has two opposite edges being respectively a first edge 141 and a second edge 142 (as shown in FIG. 4). The first edge 141 is pivotally connected to the main body 11 and the second edge 142 engages with the main body 11 to stop the positioning panel 14 from pivoting.

To be precise, the main body 11 and the positioning panels 14 are made of plastic and integrally formed. The first edge 141 forms a plastic hinge that allows the corresponding positioning panel 14 to pivot relative to the main body 11 to reduce difficulty of manufacturing. The second edge 142 forms a hook and engages with the main body 11 to fix the corresponding positioning panel 14 in a position such that the positioning panel 14 is disposed apart from the external surface of the main body 11 and being substantially parallel to the main body 11, but the second edge 142 can be formed in any other shape as long as the second edge 142 engages with the main body 11.

Moreover, the second edge 142 can be disposed apart from the main body 11 while the first edge 141 is rigidly connected to the main body 11; in this case the positioning panels 14 can still improve durability of the box-positioning portions 13 as long as the positioning panels 14 are disposed apart from the main body 11.

In the preferred embodiment, each one of the two positioning panels 14 has two parallel slots 143. Said two parallel slots 143 are formed through the positioning panel 14 or formed through the main body 11 if there are no positioning panels 14. Said two parallel slots 143 extend toward a same direction such that an area between the two parallel slots 143 is easily deformed when pressed.

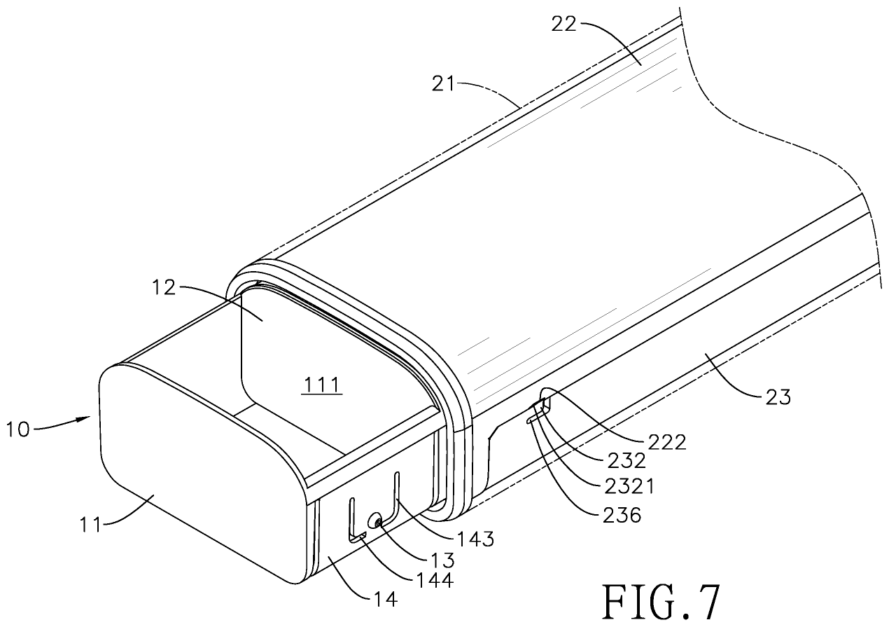

In the preferred embodiment, each one of the two positioning panels 14 further has two extending slots 144 (as shown in FIG. 7). Said two extending slots 144 are formed through the positioning panel 14 or formed through the main body 11 if there are no positioning panels 14. Each one of the two extending slots 144 is connected to an end of a respective one of the two parallel slots 143 and extending toward the other one of said two parallel slots 143 to make the area between the two parallel slots 143 more deformable. The corresponding box-positioning portion 13 is located between the two parallel slots 143 to improve durability of the box-positioning portions 13.

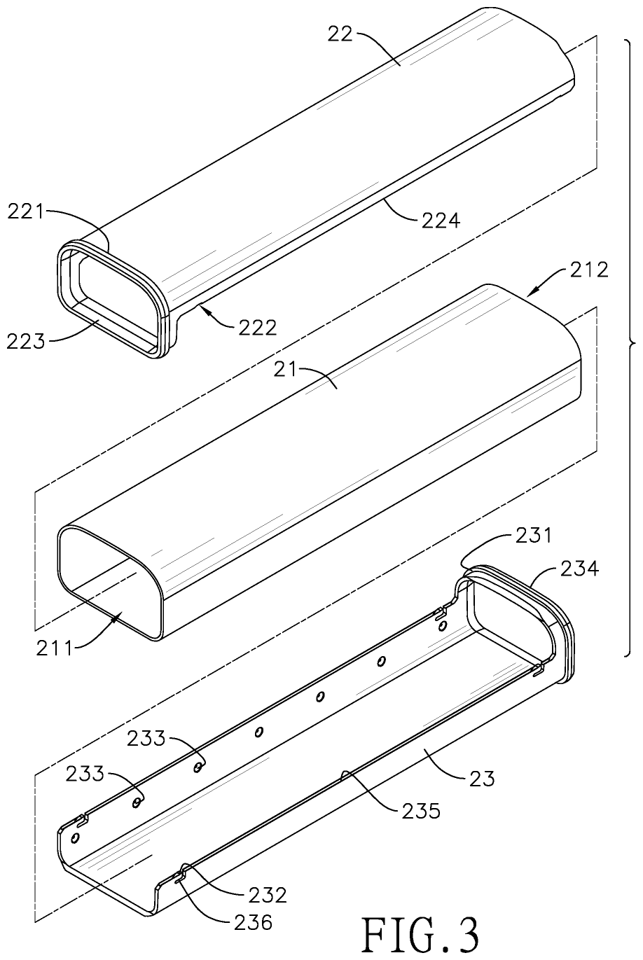

With reference to FIGS. 3 to 5, the outer housing 20 is slidably located around the sorting box 10 and has an outer tube 21, an upper half tube 22, and a lower half tube 23. The outer tube 21 has two end openings located on two opposite ends of the outer tube 21, and the two end openings are respectively a first opening 211 and a second opening 212.

The upper half tube 22 is mounted in the outer tube 21 from the first opening 211. The upper half tube 22 covers at least part of the top opening of the main body 11 and has an upper abutting surface 221 and multiple upper locking portions 222. The upper abutting surface 221 is directed toward the second opening 212 and adapted to abut against the outer tube 21 to stop the upper half tube 22 from moving toward the second opening 212. In the preferred embodiment, the upper half tube 22 has an end ring 223. The upper abutting surface 221 is annular, is located on said end ring 223, and abuts against a periphery of the first opening 211 of the outer tube 21.

The upper locking portions 222 are formed on a bottom of the upper half tube 22. In the preferred embodiment, each one of the upper locking portions 222 is a recess formed in a bottom edge 224 of the upper half tube 22.

With reference to FIGS. 3, 5, and 7, the lower half tube 23 is mounted in the outer tube 21 from the second opening. A sliding channel 24 is formed between the upper half tube 22 and the lower half tube 23. The sorting box 10 is slidably mounted in the sliding channel 24. In the preferred embodiment, one opening is formed on each end of the sliding channel 24. In another preferred embodiment, one of the two ends of the sliding channel 24 can be sealed.

The lower half tube 23 has a lower abutting surface 231, multiple lower locking portions 232, and multiple housing-positioning portions 233. The lower abutting surface 231 is directed toward the first opening 211 and configured to abut against the outer tube 21 to stop the lower half tube 23 from moving toward the first opening 211. In the preferred embodiment, the lower half tube 23 has an end ring 234. The lower abutting surface 231 is annular, is located on said end ring 234, and abuts against a periphery of the second opening 212 of the outer tube 21.

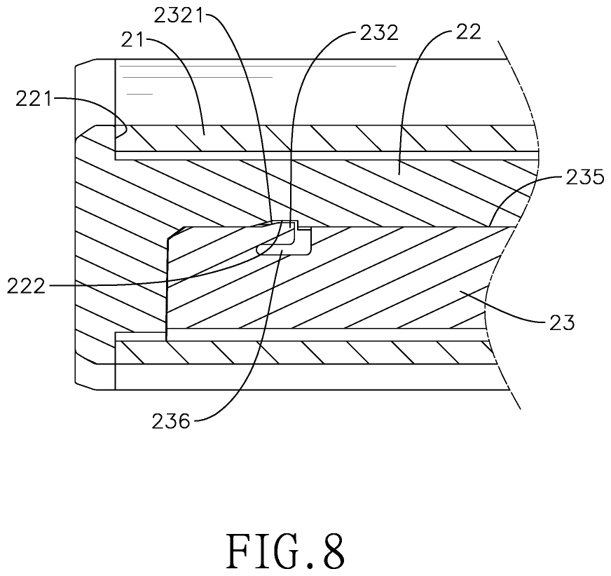

With reference to FIGS. 7 and 8, the lower locking portions 232 are formed on a top of the lower half tube 23 and engage with the upper locking portions 222 to keep the upper half tube 22 and the lower half tube 23 mounted in the outer tube 21, that is, because movement of the engagement of the two half tubes 22, 23 are partially restricted by the abutting surfaces 221,231 of the half tubes 22, 23, engagement of the locking portions 222, 232 only has to stop the two half tubes 22, 23 from moving away from each other to keep both of the two half tubes 22, 23 mounted in the outer tube 21.

With reference to FIGS. 3, 7, and 8, in the preferred embodiment, each one of the lower locking portions 232 protrudes from a top edge 235 of the lower half tube 23 and is mounted in a corresponding one of the upper locking portions 222. Each one of the lower locking portions 232 has a guiding incline 2321 formed on a side, which is directed toward the first opening 211, of the upper locking portion 222. A top of the guiding incline 2321 is inclined away from the first opening 211. The guiding incline 2321 is adapted to be pressed by the upper locking portions 222 such that when the half tubes 22, 23 are in a process of being mounted in the outer tube 21, the lower locking portions 232 can be forced to disengage from the upper locking portions 222.

In addition, the lower half tube 23 has multiple bent slots 236 formed through the lower half tube 23. Each one of the bent slots 236 is located under a corresponding one of the lower locking portions 232 such that when the guiding incline 2321 is pressed, the lower locking portion 232 can easily be deformed and disengage from the upper locking portion 222. To be more precise, an end of each one of the bent slots 236 extends to the top edge 235.

The housing-positioning portions 233 are disposed apart from each other along the lengthwise direction L. The housing-positioning portions 233 are preferably round recesses formed in the lower half tube 23. The two box-positioning portions 13 aforementioned are respectively a first box-positioning portion 131 and a second box-positioning portion 132. The first box-positioning portion 131 selectively engages with one of the housing-positioning portions 233 to keep at least one of the pill compartments 111 protruded from the first opening 211, or to keep all the pill compartments 111 retracted in the sliding channel 24. The second box-positioning portion 132 selectively engages with one of the housing-positioning portions 233 to keep at least one of the pill compartments 111 protruded from the second opening 212 or to keep all the pill compartments 111 retracted in the sliding channel 24. In another preferred embodiment, the second box-positioning portion 132 can be omitted. In another preferred embodiment, the housing-positioning portions 233 can be formed in the upper half tube 22.

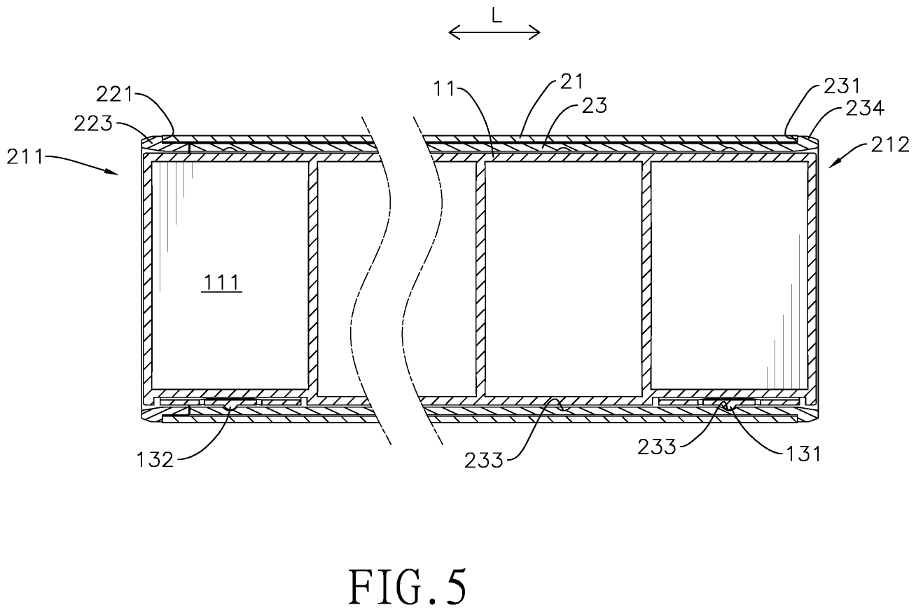

With reference to FIGS. 5 to 7, in the preferred embodiment, a distance between two adjacent ones of the housing-positioning portions 233 equals a distance between two adjacent ones of the partitions 12 such that one of the partitions 12 is aligned with said opening of the sliding channel 24 when the pill compartments 111 are protruded. In the preferred embodiment, two rows of the housing-positioning portions 233 are formed in two opposite inner side walls for ease of use.

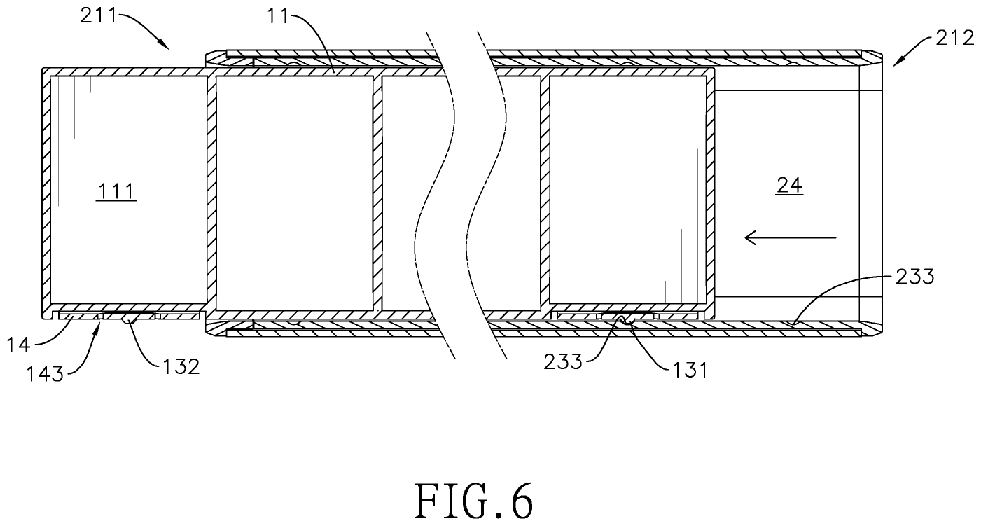

To use the pill organizer, put pills in the pill compartments 111 according to prescription. Push an end of the sorting box 10 along the lengthwise direction L to force the sorting box 10 to protrude from the outer housing 20 until the desired one of the pill compartment 111 is protruded from the outer housing 20 (as shown in FIGS. 6 and 7). Engagement of the positioning portions 13, 233 keeps the sorting box 10 at protruded positions or retracted position.

In summary, all of the pill compartments 111 of the sorting box 10 are mounted in one single outer housing 20 to reduce total number of parts of the pill organizer to save cost. The sorting box 10 is commonly retracted inside the outer housing 20, and relative movement between the sorting box 10 and the outer housing 20 is restricted by the positioning portions 13, 233 to prevent accidentally opening the outer housing 20. When the sorting box 10 is protruded from the outer housing 20, relative movement between the sorting box 10 and the outer housing 20 is restricted by the positioning portions 13, 233 for ease of use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pill organizer comprising:
a sorting box having:
a main body extending along a lengthwise direction; the main body forming an inner space and a top opening;
multiple partitions located in the main body; the partitions disposed apart from each other along the lengthwise direction to divide the inner space of the main body into multiple pill compartments;
at least one box-positioning portion formed on an external surface of the sorting box;
an outer housing slidably located around the sorting box and having:
an outer tube having two end openings located on two opposite ends of the outer tube; the two end openings being respectively a first opening and a second opening;
an upper half tube mounted in the outer tube from the first opening; the upper half tube covering at least part of the top opening and having:
an upper abutting surface directed toward the second opening and adapted to abut against the outer tube to stop the upper half tube from moving toward the second opening;
multiple upper locking portions formed on a bottom of the upper half tube;
a lower half tube mounted in the outer tube from the second opening; a sliding channel formed between the upper half tube and the lower half tube; the sorting box slidably mounted in the sliding channel; the lower half tube having:
a lower abutting surface directed toward the first opening and adapted to abut against the outer tube to stop the lower half tube from moving toward the first opening;
multiple lower locking portions formed on a top of the lower half tube and engaging with the upper locking portions to keep the upper half tube and the lower half tube connected to each other in the outer tube; and
multiple housing-positioning portions disposed apart from each other along the lengthwise direction;
wherein the at least one box-positioning portion of the sorting box selectively engages with one of the housing-positioning portions to keep at least one of the pill compartments protruded from the sliding channel or to keep all the pill compartments retracted in the sliding channel.

2. The pill organizer as claimed in claim 1, wherein
the sorting box has:
at least one positioning panel disposed apart from an external surface of the main body; an edge of the positioning panel connected to the main body; and
the at least one box-positioning portion is formed on the at least one positioning panel.

3. The pill organizer as claimed in claim 2, wherein the at least one positioning panel has two opposite edges being respectively a first edge and a second edge; the first edge is pivotally connected to the main body; the second edge engages with the main body to stop the at least one positioning panel from pivoting.

4. The pill organizer as claimed in claim 1, wherein
the main body has two parallel slots for the at least one box-positioning portion; the two parallel slots are formed through the main body and extend toward a same direction; and
the at least one box-positioning portion is formed on the main body and located between the two parallel slots.

5. The pill organizer as claimed in claim 3, wherein
the at least one positioning panel has two parallel slots; the two parallel slots are formed through the at least one positioning panel and extend toward a same direction; and
the at least one box-positioning portion is located between the two parallel slots.

6. The pill organizer as claimed in claim 4, wherein the main body has two extending slots for the at least one box-positioning portion; the two extending slots are formed through the main body; each one of the two extending slots is connected to an end of a respective one of the two parallel slots and extending toward the other one of said two parallel slots.

7. The pill organizer as claimed in claim 5, wherein the at least one positioning panel has two extending slots; the two extending slots are formed through the at least one positioning panel; each one of the two extending slots is connected to an end of a respective one of the two parallel slots and extending toward the other one of said two parallel slots.

8. The pill organizer as claimed in claim 1, wherein
each one of the upper locking portions is a recess formed in a bottom edge of the upper half tube; and
each one of the lower locking portions protrudes from a top edge of the lower half tube and is mounted in a corresponding one of the upper locking portions; each one of the lower locking portions has
a guiding incline formed on a side, which is directed toward the first opening, of the lower locking portion; a top of the guiding incline inclined away from the first opening.

9. The pill organizer as claimed in claim 7, wherein
each one of the upper locking portions is a recess formed in a bottom edge of the upper half tube; and
each one of the lower locking portions protrudes from a top edge of the lower half tube and is mounted in a corresponding one of the upper locking portions; each one of the lower locking portions has
a guiding incline formed on a side, which is directed toward the first opening, of the lower locking portion; a top of the guiding incline inclined away from the first opening.

10. The pill organizer as claimed in claim 8, wherein the lower half tube has multiple bent slots formed through the lower half tube; each one of the bent slots is located under a corresponding one of the lower locking portions.

11. The pill organizer as claimed in claim 9, wherein the lower half tube has multiple bent slots formed through the lower half tube; each one of the bent slots is located under a corresponding one of the lower locking portions.

12. The pill organizer as claimed in claim 1, wherein
the upper half tube has an end ring, and the upper abutting surface is annular, is located on the end ring of the upper half tube, and abuts against a periphery of the first opening of the outer tube; and
the lower half tube has an end ring, and the lower abutting surface is annular, is located on the end ring of the lower half tube, and abuts against a periphery of the second opening of the outer tube.

13. The pill organizer as claimed in claim 11, wherein
the upper half tube has an end ring, the upper abutting surface is annular, is located on the end ring of the upper half tube, and abuts against a periphery of the first opening of the outer tube; and
the lower half tube has an end ring, the lower abutting surface is annular, is located on the end ring of the lower half tube, and abuts against a periphery of the second opening of the outer tube.

14. The pill organizer as claimed in claim 1, wherein a number of the at least one box-positioning portion is two, wherein one of the two box-positioning portions of the sorting box selectively engages with one of the housing-positioning portions when the sorting box protrudes from the first opening; the other one of the two box-positioning portions of the sorting box selectively engages with one of the housing-positioning portions when the sorting box protrudes from the second opening.

15. The pill organizer as claimed in claim 13, wherein a number of the at least one box-positioning portion is two, wherein one of the two box-positioning portions of the sorting box selectively engages with one of the housing-positioning portions when the sorting box protrudes from the first opening; the other one of the two box-positioning portions of the sorting box selectively engages with one of the housing-positioning portions when the sorting box protrudes from the second opening.
